(19) United States
(12) Patent Application Publication
(10) Pub. No.: US 2020/0210502 A1
(43) Pub. Date: Jul. 2, 2020

(54) USER INTERFACE FOR SEARCH RESULTS

(71) Applicant: Microsoft Technology Licensing, LLC, Redmond, WA (US)

(72) Inventors: Yu Gan, Mountain View, CA (US); Xiaowei Liu, Sunnyvale, CA (US); Huiji Gao, Sunnyvale, CA (US); Bo Long, Palo Alto, CA (US)

(21) Appl. No.: 16/232,499

(22) Filed: Dec. 26, 2018

(51) Int. Cl. G06F 16/9535; G06F 16/903; G06F 16/908; G06F 16/9038

(52) U.S. Cl. CPC G06F 16/9535; G06F 16/9038; G06F 16/908; G06F 16/90348

(57) ABSTRACT

An online system and method includes receiving a search query including at least one search term, the search query being associated with a member of the online system. A data tag is separately applied to each individual search term of the search query. An ambiguity status of the search query is determined based on at least some actions as stored in an electronic data storage, also configured to store content items of the online system, including member profile data. A probability distribution of content item categories is determined based on the data tags and at least some of the actions and, if the search is ambiguous, member profile data. At least one content item associated with a content item category having a highest probability on the probability distribution and a user interface displays the at least one content item.

### TECHNICAL FIELD

The subject matter disclosed herein generally relates to a user interface for search results.

### BACKGROUND

Online systems conventionally include a variety of content items related to a diverse range of content item types. For instance, content item types may include member profiles, information or profile pages for organizations, links to third-party articles, postings for events, job openings, and items for sale, and so forth. Online systems may further include a search engine that allows users of the online social networking system to search among the content items to find content items in which they are interested.

### BRIEF DESCRIPTION OF THE DRAWINGS

Some embodiments are illustrated by way of example and not limitation in the figures of the accompanying drawings.

FIG. I is a block diagram illustrating various components or functional modules of an online social networking system, consistent with some examples.

FIG. 2 is a simplified depiction of a user interface as provided by the social networking system, in an example embodiment.

FIG. 3 is a flow diagram of the search engine in an example embodiment.

FIG. 4 is a flow diagram of a post-search assessment stage, in an example embodiment.

FIG. 5 is a flowchart for generating a user interface for displaying search results, in an example embodiment.

FIG. 6 is a block diagram illustrating components of a machine able to read instructions from a machine-readable medium.

### DETAILED DESCRIPTION

Example methods and systems are directed to a user interface for search results for an online social networking system. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Conventional user interfaces for online searches may obtain content items relevant to entered search terms and, based on a variety of factors, display the content items or links to the content items to users according to various criteria. The search results may be obtained according to factors such as keyword match and organized according to how well those factors are met. However, such conventional search engines may not be sensitive to the ambiguities that may arise, including but not limited to online environments, such as social networking environments. In particular, the social networking environment may provide context that makes a search relatively more or less ambiguous.

For instance, in the context of an online social networking system, a search string of a particular person, e.g., “John Doe”, may have little ambiguity, and the search engine may return, and the user interface may prominently display, a link to John Doe's member profile page (or a list of member profile pages of some or all of the members named John Doe). By contrast, a search with a search string consisting of a particular company, e.g., “CompanyX”, may be much more ambiguous in the context of an online social networking system. For instance, potentially relevant results may include a profile page of CompanyX, news stories including CompanyX, job postings by CompanyX, members who are employees of CompanyX, and so forth. As a result, a user interface that simply displays such search results related to CompanyX may be inefficient in the utilization of computing resources, given that spurious results would be generated and served to and displayed on the user interface, as well as inefficient to the user of the user interface, given the time that would be involved in sorting through undesired search results.

A user interface has been developed in conjunction with an engine that utilizes a two-stage search process to determine and apply a user intention behind a search query. The first stage determines if the intent of the user behind the entry of the search query was ambiguous or not, e.g., is the user intending to search for a person or a company or organization? If the user intent is unambiguous, the search engine proceeds to apply the search query to a content item category associated with the intent using a two-stage statistical model. If the user intent is ambiguous, the search engine applies the search query to a range of content item categories and supplements the search query with activity data and member profile data of the user in order to further divine user intent. Thus, if a user who has been consistently search for job posting provides “CompanyX” as a search query, the search engine may return or prioritize job listings from CompanyX over more general company profile information about CompanyX.

It is noted and emphasized that while the principles disclosed herein are done so with respect to searching the principles may be applicable to any situation within an online social networking system in which the “intention” of some person or engine may be inferred and utilized. Thus, the principles disclosed herein may further he applied to the generation of a content item feed, determining job postings a user might be interested in, and so forth. As such, the “intention” may not be the objective intent behind a specific action by a user but rather what the user would intend if they had made an affirmative request. So, while the online social networking system may automatically populate a feed of content items for a member without the member having to specifically request that the feed be generated, the “intent” of the member that their feed be populated with content items that the member cares about may he inferred and the feed of the user be populated with content items accordingly.

FIG. 1 is a block diagram illustrating various components or functional modules of an online social networking system 100, consistent with some examples. A front end 101 consists of a user interface module (e.g., a web server) 102, which receives requests from various client-computing devices, and communicates appropriate responses to the requesting client devices. For example, the user interface module(s) 102 may receive requests in the form of Hypertext Transport Protocol (HTTP) requests, or other web-based, application programming interface (API) requests. An application logic layer 103 includes various application server modules 104, which, in conjunction with the user interface module(s) 102, may generate various user interfaces (e.g., web pages, applications, etc.) with data retrieved from various data sources in a data layer 105. In some examples, individual application server modules 104 may be used to implement the functionality associated with various services and features of the social network service. For instance, the ability of an organization to establish a presence in the social graph of the social network system 100, including the ability to establish a customized web page on behalf of an organization, and to publish messages or status updates on behalf of an organization, may be services implemented in independent application server modules 104. Similarly, a variety of other applications or services that are made available to members of the social network service may be embodied in their own application server modules 104. Alternatively, various applications may be embodied in a single application server module 104. In some examples, the social network system 100 includes a content item publishing module 106, such as may be utilized to receive content, such as electronic messages, posts, links, images, videos, and the like, and publish the content to the social network.

One or more of the application server modules 104, the content item publishing module 106, or the social network system 100 generally may include a search engine 108. As will be disclosed in detail herein, the search engine 108 may access information from the data layer 105 in relation to specified factors for a search query and member profile data to determine a degree of ambiguity in a search query and the intent behind a search query. It is noted that while user-inputted search queries are discussed specifically, the principles disclosed herein may be applied to any circumstances in which content items are to be obtained and displayed to a user.

The search engine 108 may be implemented on a separate server or may be part of a server that provides other portions of the social network system 100. Thus, it is to be understood that while the search engine 108 is described as an integral component of the online social networking system 100, the principles described herein may be applied without the search engine 108 being an integral part of the online social networking system 100 or even necessarily utilizing data from a social network if information that would normally be stored in the data layer 105 is available from alternative sources.

As illustrated, the data layer 105 includes, but is not necessarily limited to, several databases 110, 112, 114, such as a database 110 for storing profile data 116, including both member profile data as well as profile data for various organizations. Consistent with some examples, when a person initially registers to become a member of the social network service, the person may be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 110. Similarly, when a representative of an organization initially registers the organization with the social network service, the representative may be prompted to provide certain information about the organization. This information may be stored, for example, in the database 110, or another database (not shown). With some examples, the profile data may be processed (e.g., in the background or offline) to generate various derived profile data. For example, if a member has provided information about various job titles the member has held with the same or different companies, and for how long, this information can be used to infer or derive a member profile attribute indicating the member's overall seniority level, or seniority level within a particular company. With some examples, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bilateral agreement by the members, such that both members acknowledge the establishment of the connection. Similarly, with some examples, a member may elect to “follow” another member. In contrast to establishing a connection, the concept of “following” another member typically is a unilateral operation, and at least with some examples, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph database 112.

Activities by users of the social network system 100, including past interactions that have resulted from prior searches conducted by the search engine 108, may be logged as activities 118 in the activity and behavior database 114. Such activities may include search terms, interactions with search results by recruiters, and subsequent engagement between the recruiter and the candidate members who were produced by searches, and so forth. Profile data 116, activities 118, and the social graph of a member may collectively be considered characteristics of the member and may be utilized separately or collectively as disclosed herein.

The data layer 105 collectively may be considered a content item database, in that content items, including but not limited to member profiles 116, may be stored therein. Additionally or alternatively, a content item layer 120 may exist in addition to the data layer 105 or may include the data layer 105. The content item layer 120 may include individual content items 122 stored on individual content item sources 124. The member profiles 116 and the activities 118 may be understood to be content items 122, while the profile database 110, the social graph database 112, and the member activity database 114 may also be understood to be content item sources 124. Content items 122 may further include sponsored content items as well as posts to a news feed, articles or links to websites, images, sounds, event notifications and reminders, recommendations to users of the social network for jobs or entities to follow within the social network, and so forth.

The social network system 100 may provide a broad range of other applications and services that allow members the opportunity to share and receive information, often customized to the interests of the member. For example, the social network service may include a photo sharing application that allows members to upload and share photos with other members. In some examples, members may be able to self-organize into groups, or interest groups, organized around a subject matter or topic of interest. In some examples, the social network service may host various job listings providing details of job openings with various organizations.

Although not shown, with some examples, the social network system 100 provides an application programming interface (API) module via which third-party applications can access various services and data provided by the social network service. For example, using an API, a third-party application may provide a user interface and logic that enables an authorized representative of an organization to publish messages from a third-party application to various content streams maintained by the social network service. Such third-party applications may be browser-based applications, or may be operating system-specific. In particular, some third-party applications may reside and execute on one or more mobile devices (e.g., phone, or tablet computing devices) having a mobile operating system.

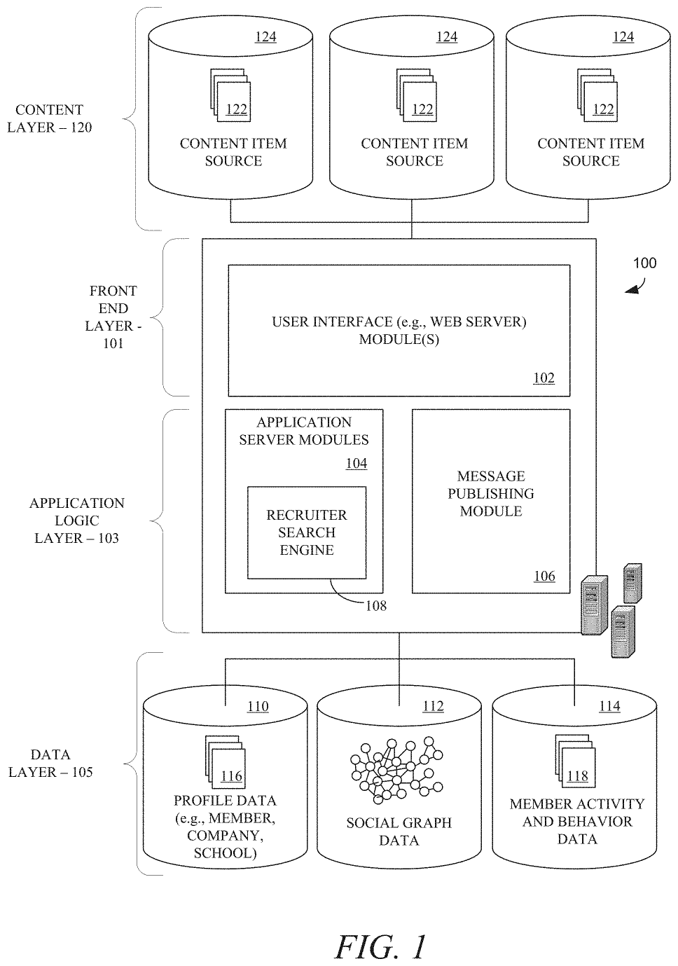

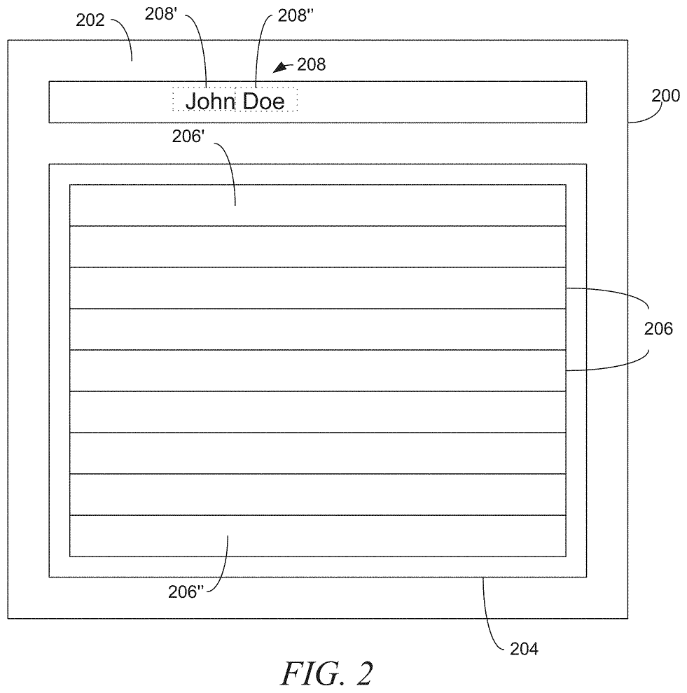

FIG. 2 is a simplified depiction of a user interface 200 as provided by the social networking system 100, in an example embodiment. The user interface 200 may be displayed on a user device, such as a personal computer, tablet computer, smartphone, and the like. The user interface 200 includes a search query window 202 and a search results window 204 including multiple ranked positions 206. Higher positions 206′ corresponding to search results with relatively high relevance to the search query and user intent and lower positions 206″ corresponding to search results with relatively lower relevance to the search query and user intent.

The search query window 202 provides the capacity for a user to enter a search query, such as a string of words or letters, searchable symbols or graphics, and the like. The search query may be utilized by the search engine 108 to search content items 122 of the online social networking system 100 as well as for content items that may be accessed from third party sources, such as external websites and databases and the like. Upon receipt of a search query, the search engine 108 breaks the search query into individual components and assign a data tag 208 to each of the components. The data tags 208 provide a basis for determining an ambiguity status or level of ambiguity in a search query.

In one example, each individual word of a search query is assigned a separate data tag 208. Thus, in the illustrated example, “John” is a first data tag 208′ and “Doe” is a second data tag 208″. As will be described in detail herein, the data tags 208 as assigned are cross-referenced against data tags 208 that have previously been assigned to content item categories and then associations between and among previous data tag 208 combinations are identified to determine an ambiguity status in a search query. Where the data tags 208 of the search query have previously been used in conjunction with one another, and those data tags 208 have been associated with a particular category, there may tend to be little ambiguity. Where the data tags 208 of the search query have never or rarely been used together before, or where a single data tag 208 has never or rarely been used before, the search query may tend to have relatively high ambiguity.

It is further noted and emphasized that a particular data tag 208 is assigned in each and every search that includes that word or search term. Thus, every time a user enters a search query that includes the word “John”, the same data tag 208′ is assigned to that search. Thus, a search query “John Smith” would have the “John” data tag 208′ and a “Smith” data tag that would not be the same as the “Doe” data tag 208″. A search query “John Hancock” would have the “John” data tag 208′ and a “Hancock” data tag 208 different than either the “Doe” data tag 208″ and the “Smith” data tag 208. It is noted and emphasized that each search term is not necessarily one word, and to the extent that proper names or phrases may conclusively be associated with one another, those words or phrases may be treated as a single search term which may have a unique data tag 208.

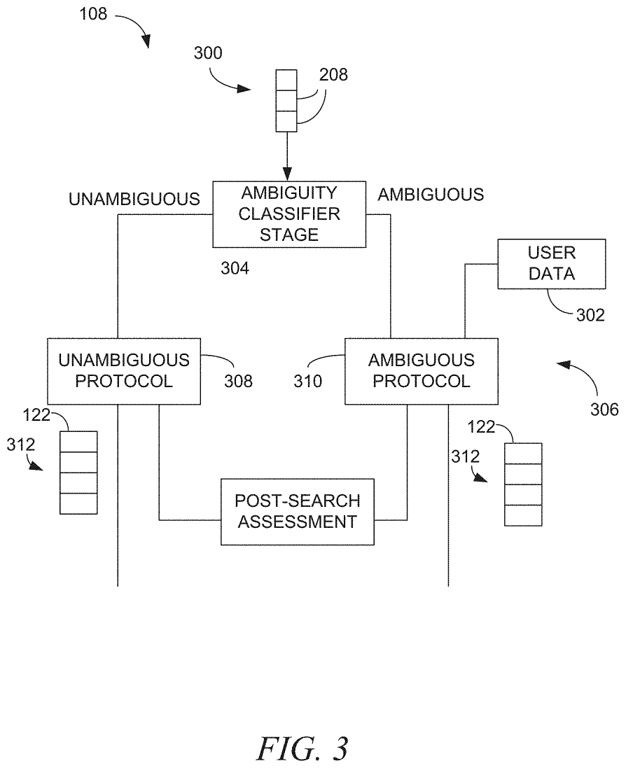

FIG. 3 is a flow diagram of the search engine 108, in an example embodiment. The search engine 108 receives data tags 208 of an input search query 300 from the search query window 202, or, in various examples, from any suitable source for a search query or other input for which the operation of the search engine 108 is desired. The search engine 108 further receives user data input 302, potentially profile data 112 and activity data 114 of the user performing the search as well as any other suitable information from the data layer 105.

The search engine 108 is a two-stage engine, including an ambiguity classifier stage 304 and a query classifier stage 306. The query classifier stage 306 includes two different protocols, an unambiguous protocol 308 and an ambiguous protocol 310, that are arrived at depending on the conclusion of the ambiguity classifier stage 304. Depending on the second stage protocol 308, 310 utilized, that protocol 308, 310 outputs either a specific content item 122 if the search is at a certain level of unambiguity and/or a ranked list 312 of content items 122 for display in the search results window 204. It is noted that while the ambiguous protocol 310 receives both the output of the ambiguity classifier stage 304 and the user data input 302, the unambiguous protocol 308 does not, in the illustrated example, receive or utilize the user data input 302.

The search engine 108 further includes an optional post-search assessment stage 314 that seeks to iteratively learn from the success or failure of the presentation of the resultant content item(s) 122 presented to the user. The success or failure may he assessed based on whether or not the user selects or otherwise interacts with the content item(s) 122 and may result in various data tags 208 being stored or updated for use in future searches. Thus, the post-search assessment stage 314 may provide for machine learning to improve subsequent performance of the search engine 108.

The ambiguity classifier stage 304 receives at least the data tags 208 from the search query 300 and applies a statistical model to the data tags 208 collectively to determine if the search query 300 is ambiguous or unambiguous, according to predetermined threshold conditions. In an example, the statistical model is a logistic regression test, in which the data tags 208 are compared against specific, predetermined raw data tags.

The predetermined raw data tags may be selected based on the nature and type of the online social networking system 100, and/or may be modified, updated, or otherwise selected based on learned experience by the search engine 108. In an example where the online social networking system is a professional networking system, the raw data tags may be: FIRST_NAME, where the data tag 208 is commonly a first or given name of a person; LAST_NAME, where the data tag 208 is commonly a last or family name of a person; TITLE, where the data tag 208 is commonly a job title; ORGANIZATION_NAME, where the data tag 208 is commonly the name of an organization, such as a company, association, group, and the like; SCHOOL_NAME, where the data tag 208 is commonly the name of a school or educational institution; GEOLOCATION, where the data tag 208 is commonly a name of or indicator for a place; SKILL, where the data tag 208 is commonly a professional skill; JOB, which may be a binary data tag 208 indicating the presence of a keyword/keywords associated with a job or profession (e.g., “job”, “jobs”, “position”, “positions”, etc.); firstHashTag, which may be a binary data tag indicating the presence of a hashtag symbol #; and UNKNOWN, where the data tag 208 is not commonly associated with any of the specified predetermined raw data tags. Each raw data tag may provide the basis for a coefficient in the logistic regression model for each of the

The function of the statistical model in the ambiguity classifier stage 304 is thus to assess a probability of the received data tags 208 corresponding to a specific raw data tag that would, as a result, tend to make unambiguous the intent of the searcher. It is noted that individual data tags 208 may potentially be associated with multiple raw data tags. For instance, the “John” data tag 208′ may most probably, based on previous searches, be associated with the FIRST_NAME raw data tag, but may also be associated with the ORGANIZATION_NAME raw data tag (from, e.g., searches that produce a company that has the word “John” in the company name) and with the SCHOOL_NAME raw data tag (from, e.g., a college or colleges that have the word “John” in their name). Similarly, the “Doe” data tag 208″may most probably be associated with the LAST_NAME raw data tag, but may also be associated with the UNKNOWN raw data tag (e.g., because a user searched on the word “Doe” intending to find information on female deer, but where the online social networking system 100 is geared towards professional networking there may relatively little information on or relevance to zoological topics).

Content item categories may be determined or assigned and may be selectable or configurable depending on the desired focus of the online social networking system 100. Each content item category may be associated with one or more of the raw data tags. For instance, in an example online social networking system 100 directed toward professional networking, predetermined categories may include: PEOPLE (e.g., member profiles); JOB LISTINGS; ORGANIZATIONS; CONTENT posted to the online social networking system by users; GROUPS; and SCHOOLS. Each category includes a coefficient corresponding to each of the raw data tags in the logistic regression model, with certain categories tending to have relatively higher coefficients for certain raw data tags owing to the inherent relationship between that category and certain raw data tags. For instance, the PEOPLE category may have relatively high coefficients for the FIRST_NAME and LAST_NAME raw data tags; the JOB LISTINGS category may have relatively high coefficients for the TITLE, SKILL, and JOB raw data tags; the ORGANIZATIONS category may have relatively high coefficients for the ORGANIZATION_NAME raw data tag; the CONTENT raw data tag may have relatively high coefficients for the GEOLOCATION and UNKNOWN raw data tags; GROUPS may have relatively high coefficients for the GEOLOCATION and UNKNOWN raw data tags; SCHOOLS may have relatively high coefficients for the SCHOOL_NAME and GEOLOCATION raw data tags.

Based on the “John” data tag 208′ being most probably associated with the FIRST_NAME raw data tag and the “Doe” data tag 208″ being most probably associated with the LAST_NAME raw data tag, the search engine 108 implementing the ambiguity classifier stage 304 may conclude that the search query 300 is most probably a person's name. If, according to the statistical model implemented by the search engine 108 in the ambiguity classifier stage 304, the probability of the “John” and “Doe” data tags 208 meets a threshold probability requirement, the search engine 108 may conclude that the “John Doe” search query is “unambiguous”. However, if the probability does not meet a threshold probability requirement, then the “John Doe” search query would be “ambiguous”. The resultant binary ambiguity status of either “ambiguous” or “unambiguous” would be the output of the ambiguity classifier stage 304 and utilized by the search engine 108 in the query classifier stage 306.

The above description describes the function of the ambiguity classifier stage 304 at a high level, and it is to be recognized and understood that any suitable mechanism for determining ambiguity may be implemented as appropriate to the circumstances. What follows is an example technical implementation for the online social networking system 100. It is to be noted an emphasized that the following description may be utilized for any binary classification. Thus, while the description relates to a specific implementation of the ambiguity classifier stage 304, the process may be utilized, e.g., to determine if an electronic message is “spam”, whether or not a member is actively seeking a job, and so forth.

For a given search query 300 a vector is created that accounts for each data tag 208 of the search query 300 in relation to the raw data tags. For the purposes of this example, suppose base vector is [“has job keyword in query?”, “confidence of ORGANIZATIONS tag”, “confidence of FIRST_NAME tag”, “confidence of SKILL tag”, . . . ], with a separate confidence coefficient for each raw data tag. It is noted and emphasized that a vector may have dozens or hundreds of coefficients as appropriate and that for our provided here for illustrative purposes. As applied to an example search query 300 “CompanyX software engineer”, the resultant vector may be [0.0, 0.99, 0.0, 0.95, . . . ], reflecting that the data tags 208 correspond not at all to the keyword “Job”; reflect approximately a 99% confidence, based on data tags 208 from previous searches, that the name of an organization is included in the data tags 208, i.e., “CompanyX”; reflect that the data tags 208 correspond not at all to a known first name; reflect approximately a 95% confidence that, based on data tags 208 from previous searches, a skill is included in the data tags 208, i.e., “software” and/or “engineer”.

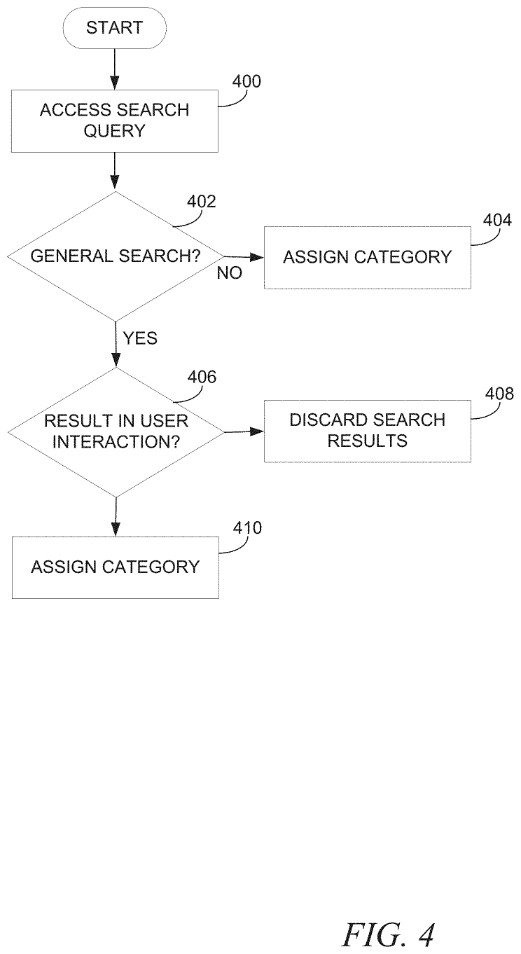

The detailed probably of the vector is calculated according to the ordinary operation of a logistic regression. In an example, the probably p of the vector [symbol] including the coefficients βᵢ is

$$p = \frac{1}{1 + {e}^{\vec{β} \cdot \vec{f}}} ,$$

in which [symbol] is the coefficients as updated according to the process of FIG. 4. If the probability meets a threshold condition, e.g., greater than 0.5 or any other desired degree of certainty, then the search query 300 is deemed to be unambiguous, otherwise the search query 300 is deemed to be ambiguous.

The query classifier stage 306 receives as an input the data tags 208, the ambiguity status, and, in the event the ambiguity status is “ambiguous”, the user data input 302. If the ambiguity status is “unambiguous” then the search engine 108 implements the unambiguous protocol 308. In the unambiguous protocol 308, the search engine 108 determines a probability distribution of the data tags 208 specifically, and the search query 300 generally, to apply to be associated with individual content item categories, as detailed above. The search engine may utilize the same logistic regression model as applied by the ambiguity classifier stage 304. Thus, for instance, the statistical model may apply a logistic regression test across the content item categories to obtain a probability distribution for the content item categories that may then be applied to a softmax test to obtain the probability distribution across the content item categories.

In an example, the softmax test generates a vector for each of the content item categories to obtain a probability for the search query 300 corresponding to each individual one of the content item categories. Thus, in the above example, the softmax test creates a vector for PEOPLE, a vector for JOB LISTINGS, a vector for ORGANIZATIONS, a vector for CONTENT, a vector for GROUPS, and a vector for SCHOOLS, each having coefficients that reflect a likelihood of the data tags 208 will, based on the results of previous searches, be associated with that category. Thus, vectors of coefficients [symbol] (i=1 . . . 7)) are obtained for each content item category. From there, the probability of the search query 300 corresponding to each content item category i is determined as

$${P}_{i} = \frac{{e}^{{\vec{β}}_{ι} \cdot \vec{f}}}{{\sum }_{i} {e}^{{\vec{β}}_{ι} \cdot \vec{f}}} .$$

If the ambiguity status is “ambiguous” then the search engine 108 implements the ambiguous protocol 310. The ambiguous protocol 310 further incorporates the user data input 302, including actions 118 by the member who is associated with the search query 300. In such an example, previous actions and activities 118 by the member may inform the intent behind the search. Such member activities may include: past member profile views; past organization profile views; past job listing views; past group views; past searches of people; past job searches; past organization searches; past group searches; past school searches; past general searches; past content item searches; social graph connections; past public comments between members; joining or leaving an organization; joining or leaving a group; following or unfollowing a school; and searching for a specific topic. The user data input 302 may further include member profile information 116, including experience with: career opportunities; responses to recruiters and/or job seekers; responses to sales people; education; entrepreneurship; finance; retail; technology, travel; and information technology.

The search engine 108 may apply a different or adapted logistic regression model to the ambiguous protocol 310 than for the ambiguity classifier stage 304 and the unambiguous protocol 308. For the ambiguous protocol 310, in addition to each of the categories having a coefficient for each of the raw data tags, each category further includes a coefficient for each of the member profile information 116 and activities 118 listed above.

In various examples, the search engine 108 may access the user data input 302 on an as-needed basis by accessing the information from the data layer 105 upon receiving the search query 300. Alternatively, the search engine 300 may proactively access the user data input 302 to prepare the user-data related aspects of the ambiguous protocol 310 prior to receipt of a search query 300, e.g., updating the coefficients in the ambiguous protocol 310 logistic regression model. In such an example, the search engine 108 may access the user data input 302, e.g., on a daily basis to update the user data proactively, in which case the search engine 108 may receive the search query 300 and the user data input 302 asymmetrically.

FIG. 4 is a flow diagram of a post-search assessment stage 314, in an example embodiment. Following the completion of the search by the search engine 108 and the selection of a search results or a user interaction with the search result, the post-search assessment stage 314 may affirmatively associate the search query 300 overall and/or the individual data tags 208 of the search query with a raw data tag and/or a content item category that was previously determined to be associated with the search query 300 and/or data tags 208.

The search query 300 is accessed at 400 and the search engine 108 determines 402 if the search query 300 was entered as a general search or as a specific search. A general search may be entered as illustrated in FIG. 2, without respect to the user indicating a particular category for the search. A specific search may be entered with respect to a specific category, e.g., the search query window 202 may include or be associated with a prompt, such as “Who are you looking for?” or “What type of job are you interested in?”, which may be associated with the “people” or “job listing” categories respectively, or may be associated more generally with a category, e.g., by being included as part of page of member profiles or job listings. Any condition in which a specific search has been conducted may be utilized to identify the search as a specific search and the search engine 108 may proceed to 404, while if a specific search has not been affirmatively utilized the search engine 108 may proceed to 406.

At 404, if a specific search has been entered, the search engine 108 assigns a category for the search of the category of the specific search. Thus, if the search query window 202 was related to the question “What type of job are you interested in?” then the search engine 108 may assign a category of “job listings” to the search query 300. The search engine 108 then updates the coefficients of the logistic regression model utilized by the unambiguous protocol 308. It is noted and emphasized that the search engine 108 may not necessarily be applicable in circumstances in which a specific search was the source of the search query 300. In other words, while the post-search assessment of FIG. 4 may be utilized with respect to any search on the online social networking system 100, regardless of if the search was specific or general, the process of FIG. 3 may not, in certain examples, be utilized in the context of specific searches.

At 406, the search engine 108 accesses activity data 118 and determines if the search results produced a user interaction, e.g., a click on a link, a scrolling through data displayed from the search, an electronic communication, a comment, etc. If there was not a user interaction with a search result the search engine 108 proceeds to 408 and does not proceed to update the coefficients of the regression models or other information around the content item categories. If there was a user interaction the search engine 108 proceeds to 410 and assigns the data tags 208 to the content item category associated with the search results but updating the coefficients of the logistic regression model utilized by the ambiguous protocol 310.

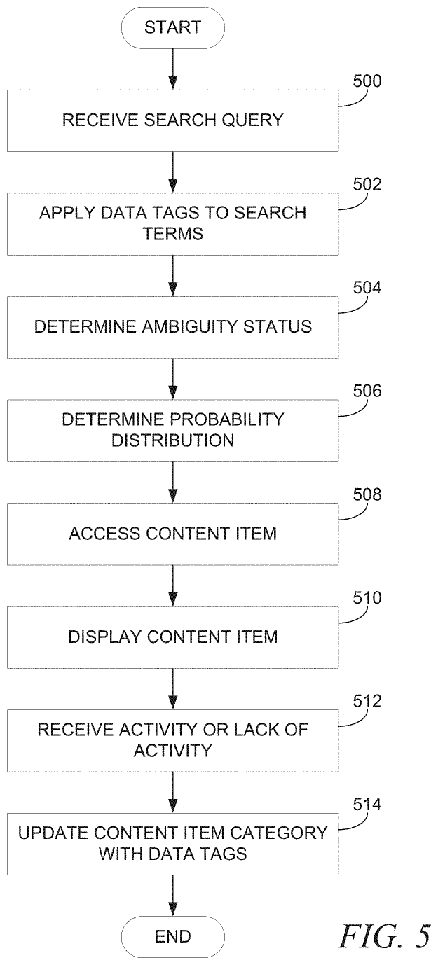

FIG. 5 is a flowchart for generating a user interface for displaying search results, in an example embodiment. The flowchart is described with respect to the online social networking system 100, but it is to be recognized and understood that the operations may be applied to any suitable system.

At 500, search query is received via a network interface, the search query including at least one search term, the search query being associated with a member of the online social networking system.

100501 At 502, at data tag is separately applied to each individual search term of the search query.

At 504, determine an ambiguity status of the search query based on the data tags applied and at least some of the actions stored in an electronic data storage of an online social networking system, the electronic data storage further configured to store content items of the online social networking system, including member profile data. In an example, the ambiguity status is a binary status indicating that the search query is either ambiguous or unambiguous. In an example, deter mining the ambiguity status is based on an ambiguity statistical model applied to the data tags. In an example, the ambiguity statistical model is a logistic regression test in relation to a predetermined threshold.

At 506, a probability distribution of content item categories is determined based on the data tags and at least some of the actions and, where the ambiguity status is determined to be ambiguous, member profile data of the member associated with the search, each of the content item categories being pre-associated with some data tags based, at least in part, the actions with content items of prior search results. In an example, determining the probability distribution is based on a statistical model of how the data tags together apply to content items within each content item category. In an example, the statistical model is a softmax function applied to an outcome of a logistic regression test.

At 508, at least one content item is accessed, the content item being associated with a content item category having a highest probability on the probability distribution.

At 510, a user interface is caused, via a network interface, to display the at least one content item.

At 512, an activity or lack of activity with the at least one content item is received via the network interface.

At 514, the content item category is updated with the data tags.

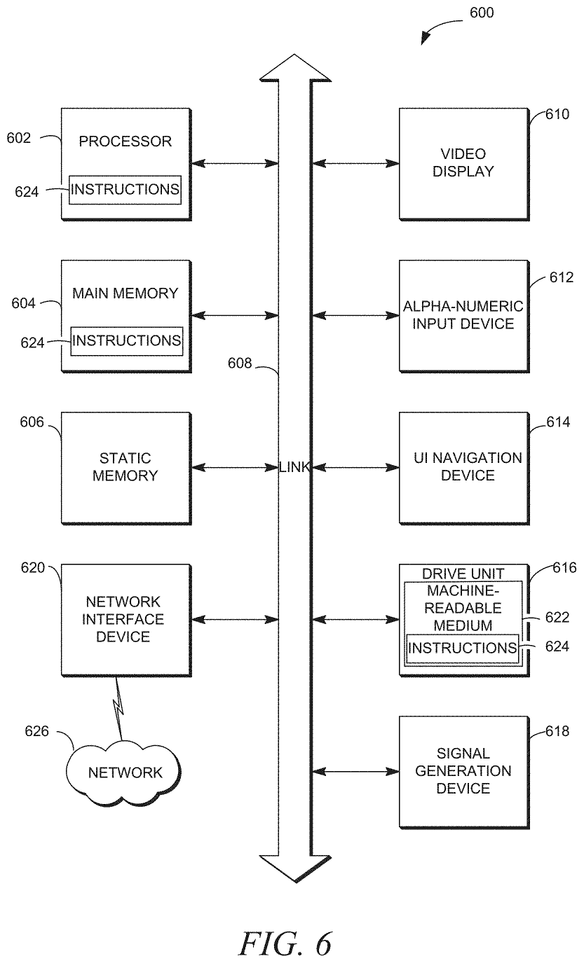

FIG. 6 is a block diagram illustrating components of a machine 600, according to some example examples, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system and within which instructions 624 (e.g., software) for causing the machine 600 to perform any one or more of the methodologies discussed herein may be executed. In alternative examples, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The machine 600 may further include a graphics display 610 (e.g., a plasma display panel (PDP), a light emitting diode (LED) display, a liquid crystal display (LCD), a projector, or a cathode ray tube (CRT)). The machine 600 may also include an alphanumeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a speaker), and a network interface device 620.

The storage unit 616 includes a machine-readable medium 622 on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media. The instructions 624 may be transmitted or received over a network 626 via the network interface device 620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 622 is shown in an example to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing or carrying instructions (e.g., software) for execution by a machine (e.g., machine 600), such that the instructions, when executed by one or more processors of the machine (e.g., processor 602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium including a signal or a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may he driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. An online system, comprising:
an electronic data storage, configured to store content items of the online system, including member profile data and actions with content items of prior search results on the online system;
a network interface, configured to receive a search query including at least one search term, the search query being associated with a member of the online system; and
a processor, operatively coupled to the electronic data storage and the network interface, configured to:
receive the search query;
separately apply, to each individual search term of the search query, a data tag;
determine, based on the data tags applied and at least some of the actions, an ambiguity status of the search query;
determine a probability distribution of content item categories based on the data tags and at least some of the actions, wherein the probability distribution is also determined based on member profile data in response to the ambiguity status being determined to be ambiguous;
access at least one content item associated with a content item category having a highest probability on the probability distribution; and
cause, via the network interface, a user interface to display the at least one content item.

2. The system of claim 1, wherein the processor is configured to determine the probability distribution based on a statistical model of how the data tags together apply to content items within each content item category.

3. The system of claim 2, wherein the statistical model is a softmax function applied to an outcome of a logistic regression test.

4. The system of claim 1, wherein the ambiguity status is a binary status indicating that the search query is either ambiguous or unambiguous.

5. The system of claim 4, wherein the processor is configured to determine the ambiguity status based on an ambiguity statistical model applied to the data tags.

6. The system of claim 5, wherein the ambiguity statistical model is a logistic regression test in relation to a predetermined threshold.

7. The system of claim 1, wherein the processor is further configured to:
receive, via the network interface, an activity or lack of activity with the at least one content item; and
update the content item category with the data tags.

8. A processor-implemented method, comprising:
receiving a search query via a network interface, the search query including at least one search term, the search query being associated with a member of the online system;
separately applying, to each individual search term of the search query, a data tag;
determining, based on the data tags applied and at least some of the actions stored in an electronic data storage of an online system, an ambiguity status of the search query, the electronic data storage further configured to store content items of the online system, including member profile data;
determining a probability distribution of content item categories based on the data tags and at least some of the actions, wherein the probability distribution is also determined based on member profile data in response to the ambiguity status being determined to be ambiguous;
accessing at least one content item associated with a content item category having a highest probability on the probability distribution; and
causing, via the network interface, a user interface to display the at least one content item.

9. The method of claim 8, wherein determining the probability distribution is based on a statistical model of how the data tags together apply to content items within each content item category.

10. The method of claim 9, wherein the statistical model is a softmax function applied to an outcome of a logistic regression test.

11. The method of claim 8, wherein the ambiguity status is a binary status indicating that the search query is either ambiguous or unambiguous.

12. The method of claim 11, wherein determining the ambiguity status is based on an ambiguity statistical model applied to the data tags.

13. The method of claim 12, wherein the ambiguity statistical model is a logistic regression test in relation to a predetermined threshold.

14. The method of claim 8, further comprising:
receiving, via the network interface, an activity or lack of activity with the at least one content item; and
updating the content item category with the data tags.

15. A non-transitory computer readable medium comprising operations which, when implemented by a processor, cause the processor to perform operations comprising:
receiving a search query via a network interface, the search query including at least one search term, the search query being associated with a member of the online system;
separately applying, to each individual search term of the search query, a data tag;
determining, based on the data tags applied and at least some of the actions stored in an electronic data storage of an online system, an ambiguity status of the search query, the electronic data storage further configured to store content items of the online system, including member profile data;
determining a probability distribution of content item categories based on the data tags and at least some of the actions, wherein the probability distribution is also determined based on member profile data in response to the ambiguity status being determined to be ambiguous;
accessing at least one content item associated with a content item category having a highest probability on the probability distribution; and
causing, via the network interface, a user interface to display the at least one content item.

16. The computer readable medium of claim 15, wherein determining the probability distribution is based on a statistical model of how the data tags together apply to content items within each content item category.

17. The computer readable medium of claim 16, wherein the statistical model is a softmax function applied to an outcome of a logistic regression test.

18. The computer readable medium of claim 15, wherein the ambiguity status is a binary status indicating that the search query is either ambiguous or unambiguous.

19. The computer readable medium of claim 18, wherein determining the ambiguity status is based on an ambiguity statistical model applied to the data tags.

20. The computer readable medium of claim 19, wherein the ambiguity statistical model is a logistic regression test in relation to a predetermined threshold.
